(19) United States
(12) Patent Application Publication
(10) Pub. No.: US 2026/0042166 A1
(43) Pub. Date: Feb. 12, 2026

(54) HIGH-TEMPERATURE JOINING FURNACE

(71) Applicant: PVA INDUSTRIAL VACUUM SYSTEMS GMBH, Wettenberg (DE)

(72) Inventors: Udo BROICH, Dillenburg (DE); Jörg WINHAUER, Dautphetal-Herzhausen (DE); Alexander TERWEY, Gießen (DE); Peter SCHLECHT, Münster (DE); Jürgen NAUMANN, Linden (DE); Stefan EICH, Asslar-Berghausen (DE); Paul JANEK, Herborn (DE); Felix GEMSE, Jena (DE)

(21) Appl. No.: 18/850,958

(22) PCT Filed: Mar. 28, 2023
(86) PCT No.: PCT/DE2023/100238

§ 371 Date: Sep. 25, 2024

(30) Foreign Application Priority Data
Mar. 29, 2022 (DE) 10 2022 107 462.5

(51) Int. Cl. B23K 20/02; B29C 65/26; B29C 65/30; H05B 3/22

(52) U.S. Cl. CPC B23K 20/023; B29C 65/26; B29C 65/30; H05B 3/22

(57) ABSTRACT

A high-temperature joining furnace is presented, which is designed for example for the diffusion bonding of joining materials such as metals, plastics, ceramics and corresponding workpieces. The joining furnace comprises a heating chamber, a workpiece holder arranged in the heating chamber for receiving a workpiece to be processed in the joining furnace, a pressing device arranged and adapted to apply a pressing force to the workpiece, wherein the pressing device comprises a pressing plate for uniformly applying the pressing force to the workpiece, and is characterized in that the pressing plate is equipped with a pressing plate heating device for heating the pressing plate and/or the workpiece.

### TECHNICAL FIELD

The present disclosure relates to a high-temperature joining furnace, a process for diffusion bonding, and a heatable press plate.

### BACKGROUND

It is generally known that metallic workpieces can be joined by diffusion bonding. For example, a metallic workpiece can be diffusion bonded if it is joined by a press under pressure at a high temperature. The diffusion bonding process is a complex procedure that depends on various influences and does not necessarily lead to a comparable or at least satisfactory result, even under the same process conditions.

During the joining process, for example, the deformation of the workpiece should be taken into account. For example, if the workpiece to be joined has cooling channels or other holes or openings in its interior, the pressing force exerted on the workpiece can deviate locally, resulting in a different overall deformation compared to a solid body with identical dimensions. The previous history of the materials to be joined can also be of importance with regard to the joining result; the grain sizes in the metal composite and the manufacturing process of the respective metal layers, for example by rolling, can be particularly relevant here. Even if different materials for different workpieces should basically be described as identical, i.e. produced using the same manufacturing process and pre-treated to the same temperatures, so that similar grain sizes should be assumed in the material, scatter widths between materials should also be taken into account. This also applies if workpieces are provided or cut out of the same piece of raw material. This can be even more difficult with certain materials and/or material combinations.

A particular challenge in the operation of a diffusion bonding system is to achieve a uniform joining result across the component. In addition to the aforementioned considerations regarding the materials to be selected, various process parameters can also be checked to see whether the process conditions can be further improved in order to further improve the uniform joining result across the component to be joined, or to make it satisfactorily available in the first place. A further improved joining result can extend the range of applications for other materials that cannot be processed or can only be processed inadequately with the existing systems. More complicated structural shapes can be joined with materials that can already be joined. This can also help to reduce production downtime.

Against this background, the present disclosure has set itself the task of further homogenizing the joining result via a component to be joined. In one aspect of the present disclosure, the task is also to be able to join new materials or more complex designs by means of diffusion bonding, which previously could not or only insufficiently be processed using this method. In a further sub-aspect, for example, the present disclosure has set itself the task of enabling operation at lower temperatures in order to be able to join materials that would be too hot with conventional joining processes and would therefore be too strongly deformed. In yet another aspect of the present disclosure, the task is to further accelerate the process sequence in order to reduce operating costs and increase component throughput.

The problem is solved by the subject matter defined in the independent claims. Dependent claims provide further embodiments and preferred embodiments of the present disclosure.

In a diffusion bonding process, a workpiece or a batch is deformed in a controlled manner. Any pores in the joining material, recesses inside the workpiece, the number and size of the joining surfaces and also the previous history of the joining material are variables that can influence the process sequence. When force is applied to the workpiece or batch by a press, the material contact on the joining surfaces is improved. In this way, inherent interdiffusion can be produced or induced. Pressing is therefore used to increase the contact surface in the area of the joining surface(s). These processes differ from workpiece to workpiece, whereby the differences can be so significant that a first component can be joined with sufficient strength, but a next component, which is to be joined with identical parameters, only achieves insufficient strength or quality. On the other hand, the shape of one component may be retained, while the next, otherwise identical component with identical parameters may, for example, suffer deformation in the area of a cooling channel due to the pressing process.

According to the present disclosure, a high-temperature joining furnace is provided, which is prepared for example for the diffusion bonding of joining materials. Joining materials can be metals and comprise metallic workpieces. Metals can be any metal-containing materials or substances. For example, this includes metals such as iron, copper, aluminum, titanium, but also alloys such as stainless steels, tool steels, superalloys, bronze, tin or others. Joining materials can also be non-metals or composite materials. Examples of non-metals include plastics or ceramics. Examples of composite materials include ceramic composites with aluminum or copper or the like.

The high-temperature joining furnace can also be set up for force-assisted soldering or sintering of components. Overall, the high-temperature joining furnace is therefore set up for pressure-loaded material refinement with or without filler material.

The high-temperature joining furnace comprises a heating chamber. In the heating chamber, the workpiece, and usually also the furnace interior, is heated to the processing temperature.

A workpiece holder is arranged in the heating chamber to hold a workpiece to be processed in the joining furnace. Typically, the workpiece holder is located on the underside of the heating chamber. For example, the workpiece holder can comprise a plate, but also holders into which the workpieces to be joined are to be inserted. The workpiece holder can be part of a counter-pressing element or be arranged on it. In other words, the workpiece holder can be a passive counterpart for a pressing device or can itself be subjected to a pressing force from below the workpiece holder and thus represent a counterpressing element.

The joining furnace also comprises the pressing device, which is arranged and designed to apply a pressing force to the workpiece. For example, the pressing device is arranged so that an upper part, such as a press punch, presses against the workpiece from above, whereby the workpiece is pressed against the workpiece holder or against the counter-pressing element. In other words, the workpiece is clamped between the upper part or press punch and the counter-pressing element or workpiece holder.

The upper part comprises a press plate for this purpose, by means of which the pressing force can be evenly distributed and applied to a surface so that the workpiece is pressed evenly. Depending on the intended use or shape of the workpiece, the press plate can have a flat surface so that the workpiece can be evenly subjected to pressing force via the surface of the press plate. The press plate can also have recesses, protrusions or steps in order to shape the press plate to a desired surface of the workpiece or workpieces. Thus, the press plate could be generally described as a “press element”. In the following, the term “press plate” is used, as this term appears to be common to the skilled person in the light of the present description.

The press plate is equipped with a press plate heating device for heating the press plate and/or the workpiece. For example, the press plate is a pressure distribution plate, as it distributes the pressing force generated by the pressing device and applied to the workpiece over the surface of the workpiece. By means of the press plate heating device, the press plate can be tempered or heated as evenly and homogeneously as possible over its surface. This also enables homogeneous heat dissipation across the press plate so that the workpiece can also be heated evenly. In other words, the workpiece can now be heated conductively by means of the press plate heating device, which may enable a considerably faster heat transfer into the workpiece and also a more even heat input over the surface of the workpiece. Furthermore, the use of the press plate heating device enables the use of materials that require a significantly lower processing temperature, at which radiant heat may not be able to transport sufficient heat output into the workpiece, so that a uniform temperature distribution in the workpiece may not even be possible using radiant heat alone. The press plate heating device according to the present disclosure thus opens up the use of new materials as workpieces that were previously not available for diffusion bonding.

The press plate heating device can preferably be integrated into the press plate, i.e., it can be fully integrated. In this case, a heat supply can be fed or connected to the press plate from outside and supply the press plate heating device with heat. If the press plate heating device is integrated into the press plate, the heat transfer into the press plate is as seamless as possible, i.e., conductive.

The press plate can be a multi-part press plate. In a multi-part press plate, a workpiece-side layer and a press-side layer can be included, and the press plate heating device can preferably be arranged between the workpiece-side layer and the press-side layer of the press plate.

The joining furnace can have flexible connectors for connecting the press plate heating device to an energy source. For example, the flexible connectors can comprise a metal strip material, such as a copper strip, which is able to compensate for movements, shocks or vibrations while maintaining electrical contact.

The press plate heating device provides a conductive heat output for the press plate, i.e., it is a conductive press plate heating device. For example, the press plate heating device is designed to be electrically operable so that it emits heat when it is supplied with electrical power from the energy source. Alternatively or cumulatively, the press plate heating device can be set up so that fluid can flow through it, so that it emits heat when a hot fluid is applied to it by the energy source.

The press plate can be movable, for example the press plate is displaced by one or more press punches, whereby the press punch(es) is/are set in motion by one or more press cylinders. When a pressing force is applied, the workpiece is successively deformed or joined.

The pressing device can also be arranged in such a way that it presses onto the workpiece from below, for example by providing a movable workpiece holder and moving the workpiece upwards on the workpiece holder, for example. In a further embodiment of the present disclosure, a first and second press plate can be provided for applying force on both sides, for example an upper and a lower press plate or a left and a right press plate.

To press the workpiece, a part that functions like a press punch is typically used, which can be subjected to a force from the outside, and a counter-pressing element that counteracts the pressing force. The workpiece is clamped between the press punch and the counter-pressing element and is joined or formed there.

The joining furnace can include a wall-side heating device or furnace heating device in the furnace chamber. The wall-side heating device can be designed to heat the workpiece by means of heat radiation. Since a low pressure, i.e., a vacuum of the highest possible quality, is typically set in the furnace chamber, there is practically no convection in the furnace chamber, so that a wall-side heating device can transmit radiant power. The wall-side heating device can compensate for any heat losses resulting from the fact that the workpiece arranged in the furnace chamber continuously emits a quantity of heat through radiant heat. The wall-side heating device can therefore be used as a support to further homogenize the temperature distribution in the workpiece. The furnace heating device can also be provided solely to emit radiant heat into the furnace chamber. The two heating devices—i.e., the press plate heating device and the furnace heating device—can complement each other in that the furnace heating device compensates for the radiation of heat away from the workpiece by radiating heat into the workpiece. In this way, any cold spots that may occur on the workpiece, particularly on the side edges, can be avoided. Depending on the design of the workpiece to be pressed or the requirements, however, the furnace heating device may not be necessary, as the press plate heating device is able to provide a uniform heat output over the surface of the workpiece by conductive transfer.

A sensor device can be provided in the joining furnace, which provides at least one sensor signal. For example, the sensor device can detect the position or extended length of the press punch, or the position of the press plate. The sensor signal can be transferred to or processed by a control device, which is designed to control at least the pressing device in response to the at least one sensor signal.

The sensor device of the joining furnace can detect a process parameter. A process parameter can be the thickness of the workpiece, the position of a pressure ram or pressing ram of the pressing device. A process parameter can also be the applied pressing force, a hydraulic pressure or a distance traveled by the pressing device. A sensor signal can then be generated from the value base recorded by the sensor device, i.e., one of the aforementioned process parameters. Several sensor devices can be provided in order to record different process parameters simultaneously. A further sensor device can detect one or more process parameters at the same time as the first sensor device and thus generate at least one or more further sensor signals. The one or more sensor signals can be processed to control the joining process or the joining furnace, so that different process parameters can be taken into account in the control.

The pressing device can comprise a hydraulic device, whereby the pressing force is built up by building up hydraulic pressure. The pressing device can also include an electric spindle, which generates a feed, for example by rotation, and applies the pressing force to the workpiece.

The joining furnace can include an input device for entering process parameter settings. The input device can be a user-operated terminal, for example. Process parameter specifications that can be stored before the start of the joining process are, for example, the desired process temperature, the process time, the material or materials of the workpiece, parameters or other data on the underlying material and the number and/or amounts of the joining surface or joining surfaces of the workpiece.

For example, the workpiece can include a number of layers of different materials, for example at least two different materials which are stacked on top of each other, whereby each surface to be joined between two different materials is described as a joining surface. In the case of a plate-like workpiece comprising 25 layers, for example, 24 joining surfaces are thus arranged in the workpiece. Information about cavities in the workpiece can also be taken into account in the process parameter specifications.

The joining furnace can also include an output device, for example for displaying or selecting process parameters and/or a control program. For example, information on which process step the joining furnace is currently in can be displayed on the output device.

The pressing device can comprise a pressing punch with which the pressing force is transferred and/or it can comprise a press plate with which the pressing force is applied to the workpiece.

The pressing device can comprise a pressing cylinder. The press punch can be connected to the press cylinder so that the press cylinder acts on the press punch with the pressing force and adjusts the press punch in the direction of the workpiece. The pressing device may comprise several pressing cylinders, for example 2, 3 or 4 pressing cylinders.

It is preferable to use several pressing punches which act together on the workpiece, for example via the press plate, which is subjected to pressing force by the two or more pressing punches as homogeneously or evenly distributed over the surface as possible. The several pressing punches can be arranged next to each other so that an array of pressing punches acts on the press plate. The aim here is to distribute the pressing force as homogeneously as possible on the workpiece to be joined, as the pressing force required for joining can otherwise deform the press plate or the press element so that the workpiece to be joined is not uniformly subjected to pressing force.

The high-temperature joining furnace can comprise a housing. For example, the heating device, heating chamber, workpiece holder and/or pressing device can be accommodated in the housing. The pressing device can be arranged on the housing by means of a press mount and/or be supported on the housing. For example, the press mount is attached to the housing or rests against the housing so that the press cylinder connected to the press mount can be supported against the housing of the high-temperature joining furnace.

For the purpose of supporting the pressing device on the housing, the housing can have a support or retaining structure such as a support frame or support cage. The support or retaining structure can be a component separate from the housing or integral with the housing.

The supporting or holding structure and/or the press mount can be designed to be movable and/or deformable. For example, the pressing device can counter-support itself against the press mount when a pressing force is applied to the workpiece, thereby displacing and/or deforming the press mount, for example by deforming the supporting or holding structure. Here, a storage force can be absorbed between the press mount and the pressing device, for example the press cylinder with press punch, similar to the pretension of a spring, so that the pressing effect on the workpiece can be increased evenly or more gently, for example when the pressing force is increased. The movable and/or deformable design of the press mount or the support or holding structure can be used to prepare the pressing device, in which the pressing device is prepared in an initial position in which a pre-pressing force is already applied to the workpiece.

The joining furnace can be set up in such a way that a lateral displacement and/or deformation of the press mount takes place by means of the application of the compressive force by the pressing device on the workpiece. In other words, the application of the compressive force to the press mount, which acts as an abutment for the press, causes the lateral displacement and/or deformation of the press mount. By absorbing the compressive force in or in the area of the press mount, a spring effect is generated between the press mount and the pressing device or between the press mount, the press cylinder and the press punch.

The pressing device can be set up in such a way that a pre-tensioning force can be built up between the pressing punch and the housing during a pressing process or when a pressing force is built up. The presence of a pre-tensioning force in the pressing device allows finer dosing and therefore more precise detection and/or tracking of the punch position during the pressing process. Furthermore, the build-up of the pre-tensioning force allows more precise setting or metering of pressure corrections or pressing force corrections.

For example, the press mount can be displaced or deformed by more than 1 mm when a compressive force is applied, for example more than 3 mm, more particularly more than 5 mm, or even more than 10 mm. This can form a type of “spring mechanism”, i.e., a preload force. The press mount can also be displaced or deformed by less than 3 mm, preferably less than 6 mm, more preferably less than 12 mm, when a compressive force is applied; minimum and maximum deflection values can be combined as an interval, for example more than 3 mm and less than 6 mm as “in the range between 3 and 6 mm”.

The sensor device can be designed to detect the position of the press punch. The sensor device can also be designed to detect the pressing force that is applied to the workpiece.

The control device can be set up to determine a pressing force required for the inserted workpiece for a joining process by recording and evaluating the sensor signal(s). Furthermore, the control device can automatically control the pressing device based on the determined required pressing force. In other words, the control device controls the pressing device taking into account the recorded or evaluated sensor signals.

If necessary, the control device can also regulate or control the heating device so that different temperatures can be maintained in the heating chamber at different times during the joining process.

The joining furnace can have a filling and removal opening. In one example, the filling and removal opening is connected to a safety circuit that detects the status of the opening.

The workpiece holder can serve as a counter-pressing element for the pressing device. The pressing device can therefore press the workpiece against the workpiece holder so that the workpiece is clamped between the pressing device and the workpiece holder.

The control device can provide at least one selectable control program. The selectable control program can preselect basic parameters, for example a typical pressing force that is frequently applicable for a certain material combination, or a minimum pressing tension with which the joining process can be started. The selectable control program can include a pre-treatment program and/or a press execution program.

The control equipment is preferably designed to adapt a selected control program in response to at least one sensor signal, particularly during the execution of the control program. The control program can be adapted in such a way that process parameters, such as for example the pressing force, temperature and/or path of the pressing device, are changed or influenced during the joining process.

The at least one control program can be stored in a program memory of the high-temperature joining furnace. The control device can comprise a programmable logic controller.

The joining furnace is preferably designed for carrying out joining processes, for example in the case of metals or metallic workpieces, at temperatures of 1200° C. or lower, preferably 1000° C. or lower, more preferably 950° C. or lower. This means that the high-temperature joining furnace is able to carry out diffusion bonding processes at lower temperatures than previously known for metals or metallic workpieces, and thus introduce new materials to diffusion bonding that could not previously be processed using this method. At lower temperatures, the time required to introduce sufficient radiation energy into the workpiece to be processed is significantly greater, and it may even be the case that irradiation and radiation are in balance or that a homogeneous temperature distribution cannot be achieved inside the workpiece. These problems are solved with the press plate heating device presented here. The joining furnace can also be designed to carry out joining processes at temperatures of 450° C. or higher, for example 500° C. or higher, preferably 550° C. or higher and more preferably 600° C. or higher.

The joining furnace can also be set up to carry out joining processes, for example in the case of non-metals such as plastics, ceramics or corresponding workpieces, at temperatures of 350° C. or lower, preferably 300° C. or lower, more preferably 250° C. or lower, or even at 200° C. or lower. This temperature range also opens up access to new materials for the diffusion bonding process. The joining furnace can also be designed to carry out joining processes at temperatures of 80° C. or higher, for example 100° C. or higher, preferably 120° C. or higher and more preferably 140° C. or higher.

The present disclosure further describes a method of diffusion bonding in a high temperature joining furnace, for example as described above. The method for diffusion bonding comprises the steps of: Filling the joining furnace with a workpiece; applying at least one press plate of a pressing device to the workpiece; heating the workpiece predominantly by means of a press plate heating device to a joining temperature; pressing the workpiece with a pressing device to carry out, for example, the diffusion bonding process.

The method can be further developed by the step: during pressing, tempering or heating the press plate by means of the press plate heating device to homogenize the temperature distribution in the workpiece.

Furthermore, the method can be formed by the step of: detecting or determining the pressing force required for the joining process during pressing, for example with an automatic control device such as a programmable logic controller (PLC); and controlling the pressing device in response to the detected or determined pressing force required for the joining process. For example, the required pressing force can be determined via the pressing path by means of distance measurement.

The method can also be further developed by the step of repeatedly detecting or determining the pressing force required for the joining process, for example at fixed time intervals, and adaptively controlling the pressing device in response to the repeatedly detected or determined pressing forces.

The method can also be further developed with the step of continuously monitoring the joining process by means of at least one sensor device, and continuously adapting the joining process when a deviation of a monitored value from a target value is detected.

The method can also be further developed with the step of entering process parameter specifications, for example by a user, before pressing the workpiece.

In addition, the step of taking into account the process parameter specifications when providing setpoints for the automated process control can also represent a further development of the method.

The present description also describes a heatable press plate, for example for a high-temperature joining furnace, as explained above. The press plate is designed for the uniform application of a pressing force to a workpiece placed in the high-temperature joining furnace. The press plate is characterized in that the press plate is equipped with an integrated press plate heating device for heating the press plate and/or the workpiece.

In an embodiment, the press plate heating device is integrated into the press plate, preferably fully integrated. The press plate can be a multi-part press plate, for example comprising a workpiece-side layer and a press-side layer of the press plate. The press plate heating device can be arranged between the workpiece-side layer and the press-side layer.

Each part of the press plate, i.e., for example the layer on the workpiece side, the layer on the press side and possibly the press plate heating device, can include the same basic material but have different dopings. The press plate can comprise ceramic material. The layer on the workpiece side and/or the layer on the press side can comprise ceramic material or consist of ceramic material. Furthermore, the press plate heating device can comprise ceramic material or also metal material or consist of ceramic material or metal material.

The ceramic material of the heatable press plate can comprise at least one of carbon fiber-reinforced graphite, carbon fiber-reinforced silicon carbide, titanium zirconium-reinforced molybdenum, silicon carbide or aluminum oxide fiber reinforced oxide ceramic. The workpiece-side layer and/or the press-side layer can also consist of one of the aforementioned materials.

The press plate heating device of the heatable press plate can comprise or consist of at least one of tungsten, molybdenum, a nickel-based alloy such as Microfer, a non-oxide ceramic such as silicon carbide or graphite, or also carbon fiber-reinforced carbon (CFC).

The press plate heating device can be plate-shaped. The press plate heating device can also be meander-shaped. The press plate heating device can have channels or tracks. The channels or tracks can penetrate the press plate so evenly that the material of the press plate has a distance from one of the channels or tracks that is at most twice the width of one of the channels or tracks or less. Such a distribution of the channels or tracks in the press plate provides the most homogeneous heat distribution possible for the press plate.

The press plate heating device can be electrically operated so that it emits heat when current is applied to it. Alternatively or cumulatively, the press plate heating device can be set up so that fluid can flow through it, so that it emits heat when a hot fluid is applied to it.

The press plate heating device can preferably have two or more heating plates. The press plate heating device can also have a connecting piece for connecting two or more sub-areas, such as heating plates, wherein the connecting piece for example comprises or consists of graphite.

The connecting piece can be designed to be reversibly deformable, so that it deforms when a compressive force is applied, for example becomes wider, and improves or establishes the electrical contact between the sections of the press plate heating device. In other words, the connecting piece is arranged in the press plate heating device in such a way that at the moment when a compressive force is applied to the press plate, the electrical contact between the sections of the press plate heating device is improved by means of the connecting piece or is established in the first place, thus improving the operational safety of the press plate heating device. It should also be taken into account that the compressive forces applied to the press plate are very high and that suitable materials are characterized on the one hand by the fact that they withstand the given conditions of pressure and temperature and on the other hand that the materials used are not marked in the joining result. For example, materials of different densities are often recognizable by the fact that they are imprinted on the workpiece to be processed like a stamp and the arrangement of materials of different densities or at least different hardnesses can be recognized in the finished workpiece. This should be prevented as far as possible. This can also be achieved with the press plate heating device presented here.

The heatable press plate can also comprise a pressure equalization layer precisely for this aspect. The pressure equalization layer may be designed to cover the entire surface and may be flexible or compressible. The pressure equalization layer can be arranged adjacent to the press plate heating device, for example placed on the press plate heating device and possibly completely covering the press plate heating devices. The pressure equalization layer can be a graphite foil. The pressure compensation layer enables further homogenization of the compressive force across the press plate, whereby local differences in the hardness or density of the materials used for the press plate heating device do not lead to a stamp-like impression in the workpiece to be joined, or lead to a much lesser extent.

The layer on the press side and/or the layer on the workpiece side can be designed as a tile carpet, for example as a ceramic tile carpet. The use of small components, such as a tile carpet for example, can mean that unevenness, for example edges of the heating device, can be compensated for and force can be distributed via the tiles of the tile carpet and thus via the press plate. The press plate heating device can be arranged in a heating plane, i.e., in other words, the press plate heating device is limited to a vertical area in the press plate and is enclosed by press plate material on both the underside and the upper side. Ceramic tiles can be arranged between components of the press plate heating device.

In the following, the present disclosure is explained in more detail with reference to embodiments and with reference to the figures, whereby identical and similar elements are sometimes provided with the same reference signs and the features of the various embodiments can be combined with one another.

### BRIEF DESCRIPTION OF THE DRAWING FIGURES

FIG. 1a first embodiment of a high-temperature joining furnace in side sectional view with inserted workpiece,

FIG. 2 a further embodiment of a high-temperature joining furnace in side sectional view, whereby the pressing device is applied to the workpiece or exerts a pressing force,

FIG. 3 Top view of a heating plate of a press plate heating device,

FIG. 4 Side sectional view of a heating plate,

FIG. 5 Side view of a heating plate,

FIG. 6 perspective view of a continuous heating plate,

FIG. 7 Perspective sectional view of a continuous heating plate,

FIG. 8 perspective partial sectional view of a press plate heating device with split heating plate,

FIG. 9 Side sectional view of the embodiment of FIG. 8,

FIG. 10 View of a split heating plate,

FIG. 11 Side view of a heating plate,

FIG. 13 View of a press plate with press plate heating device,

FIG. 14 Perspective view of a press plate with press plate heating device,

FIG. 15 Perspective partial sectional view of a press plate with press plate heating device,

FIG. 16 Further perspective partial sectional view of a press plate with press plate heating device,

FIG. 17 perspective view of a flexible connector for a press plate heating device,

FIG. 18 Side view of a flexible connector,

FIG. 19 Perspective partial sectional view of a further embodiment of a press plate with press plate heating device with ceramic meander,

FIG. 20 Perspective partial sectional view of a further embodiment of a press plate with a press plate heating device with ceramic tiles,

FIG. 21 A perspective view of a high-temperature joining furnace,

FIG. 22 Another perspective view of a high-temperature joining furnace,

FIG. 23 A perspective view of a high-temperature joining furnace with peripheral attachments,

FIG. 24 Top view of a high-temperature joining furnace,

FIG. 25 Perspective view of a high-temperature joining furnace,

FIG. 26 a flow chart for a joining process.

### DETAILED DESCRIPTION

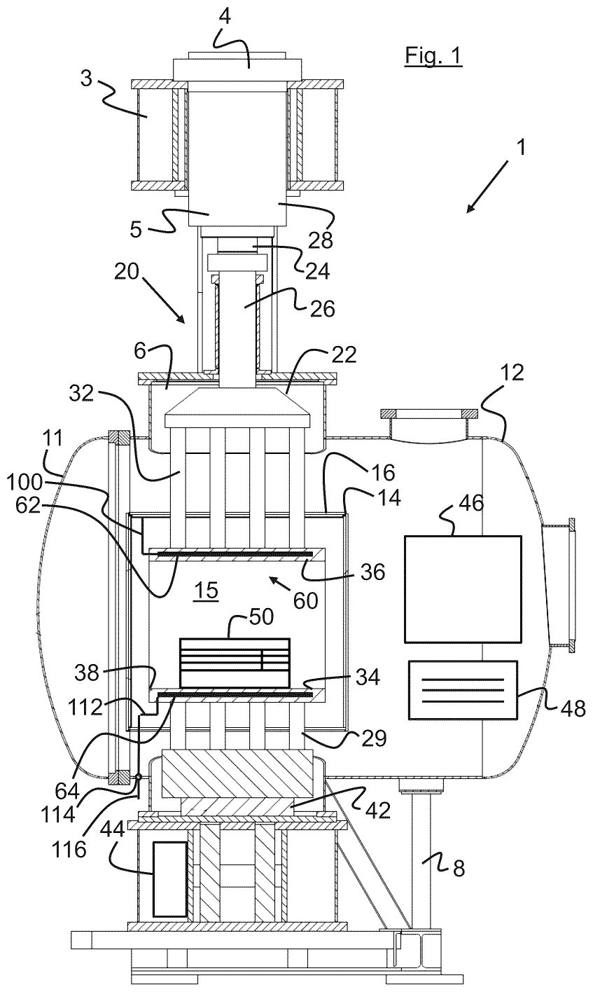

FIG. 1 shows a first embodiment of a high-temperature joining furnace 1 with a heating chamber 15 arranged inside the housing 12, in which a workpiece 50 is arranged for a subsequent pressing process. The joining furnace 1 has a filling or removal opening 11 through which the workpiece 50—or several workpieces 50 or a batch-can be inserted into or removed from the heating chamber 15. The workpiece 50 lies on the workpiece holder 34, which is arranged on the underside of the heating chamber 15. The workpiece holder 34 can be the counter-pressing element 38 or be designed as a counter-pressing element 38 or be arranged on the counter-pressing element 38. In the example shown in FIG. 1, the workpiece 50 rests directly on the counter-pressing element 38, which also forms the workpiece holder 34. Depending on the design of the workpiece 50, the workpiece holder 34 can be placed on the counter-pressing element 38.

In this embodiment, the pressing device 20 is arranged on the upper side of the housing 12 of the joining furnace 1 in order to be able to develop a pressing force from above onto the workpiece 50 and against the workpiece holder 34 or the counter-pressing element 38. A plurality of press punches 32—four press punches 32 in the example shown in FIG. 1—are connected to a press cylinder 24. The pressing cylinder 24 is, for example, a hydraulic cylinder, whereby the pressing punches 32 are set by the pressing cylinder 24 via the transmission piece 26 in the direction of the workpiece 50. A pressure distribution element 22 is arranged in the receiving area 6 of the housing 12 in order to distribute the pressing force of the pressing device 20 to the plurality of pressing punches 32.

Instead of the plurality of press plungers 32, a single press plunger 32 can also be used if necessary. By means of the plurality of pressing punches 32, e.g., 4, 8 or 12 pressing punches 32, the pressing force can on the one hand be distributed evenly (more evenly) over the pressing element 36. For example, an improved thermal sealing of the heating chamber 15 can also be achieved with the aid of the plurality of press plungers 32, since each press plunger 32 requires only a comparatively small opening in the insulation 16 of the heating chamber 15, so that the energy losses from the heating chamber 15 can be lower. In addition, by using a plurality of press plungers 32, the thermal energy losses can also be better equalized via the outer surface of the heating chamber 15 and an overall improved homogenization of the temperature distribution in the heating chamber 15 can be achieved. This also applies analogously to the counter-pressing plungers 29 on the underside of the heating chamber 15, whereby the considerations of the more homogeneous pressure distribution over the counter-pressing element 38 as well as the lower and/or more uniform heat losses are taken into account.

A press force generator 28, in this example a hydraulic unit 28, applies pressurized hydraulic fluid to the press cylinder 24 so that it is released or disengaged by the press force generator 28 and applied to the workpiece 50. For example, motor units 3 can generate the hydraulic pressure in the press force generator 28.

A first sensor device 4 is arranged on the upper side, which is used to measure the path of the press cylinder 24. Accordingly, the first sensor 4 detects the distance of the press cylinder 24 or the distance of the press plunger 32 or the extension (stroke) of the press cylinder 24 and provides a first sensor signal from this. A further sensor 5 can be arranged in the pressing force generator 28 and/or in the pressing cylinder 24, for example for measuring the hydraulic pressure, in order to derive information about the applied pressing force and provide it as a sensor signal.

The workpiece holder 34 is arranged within the heating device 14 in order to accommodate the workpiece 50 in the heating chamber 15. Also, in order to impair the insulation 16 accommodating the heating chamber 15 as little as possible, the workpiece holder 34 is provided with a plurality of counterpressing punches 29 which dissipate the force distribution from the counterpressing element 38 as evenly as possible, so that the counterpressing element 38 is subjected to as little deformation as possible. Since the counter-pressing punches 29 pass through the insulation 16 and the insulation 16 should be impaired as little as possible, a comparatively small penetration area can be caused overall or the counter-pressing punches 29 can be better thermally sealed.

A second sensor device 42 is also arranged on the underside, which can, for example, detect the pressing force applied to the workpiece 50. For example, the second sensor device 42 is a pressure sensor. A plurality of two or more pressure sensors can also be used as the second sensor device 42, for example one each in the area of a counter-pressing punch 29, so that the pressure distribution acting on the counter-pressing element 38 can be detected and output as a sensor signal. In this way, it is possible to detect whether the pressure distribution on the workpiece or the charge 50 occurs in the desired manner, for example homogeneously over the workpiece or the charge 50.

In an alternative embodiment, a pressing force can be exerted on the workpiece or the charge 50 from both sides. For example, the embodiment of FIG. 1 can be modified so that instead of the (passive) subassembly, which for example comprises counterpressing punch 29 and counterpressing element 38, a further pressing device 20′ is arranged on the underside of the high-temperature joining furnace.

In this example, an automatic process control 44 is arranged in the area of the substructure 8 of the joining furnace 1. The input device 48 and the output device 46, for example keyboard 48 and screen 46, enable inputs and outputs to the control device 44 and thus manual influence on the process sequence or input of process parameters.

In the high-temperature joining furnace 1 shown in FIG. 1, in which the upper-side press plate 36 has the press plate heating device 62 and the counterpressing element 38 has the press plate heating device 64, the two press plate heating devices 62, 64 can be of similar or identical design in terms of form and function, especially if both press plate 36 and counterpressing element 38 are provided in the form of press plates. If both plates 36, 38 are equipped with a press plate heating device 62, 64, the heat distribution in the workpiece 50 can be further homogenized and, if necessary, the time required for heating the workpiece 50 can be further reduced.

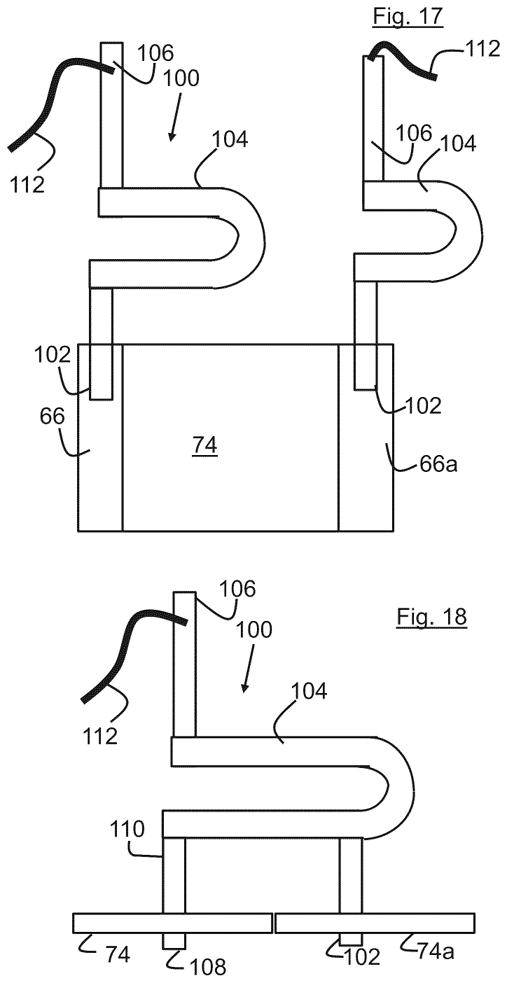

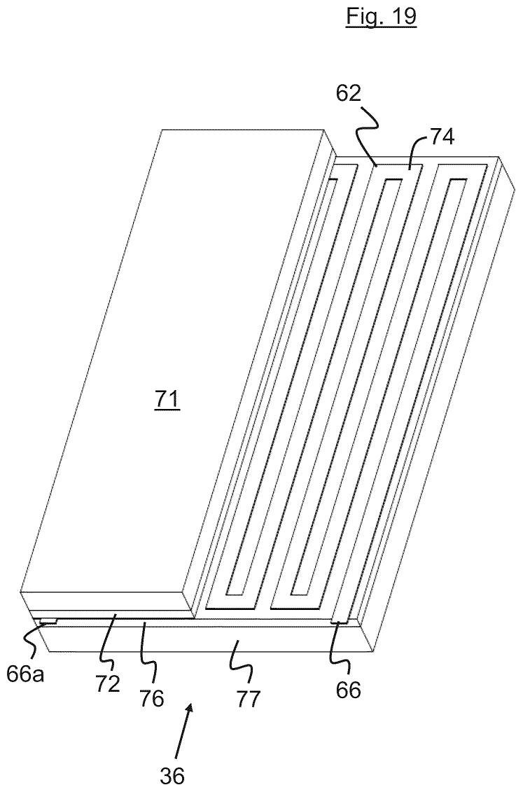

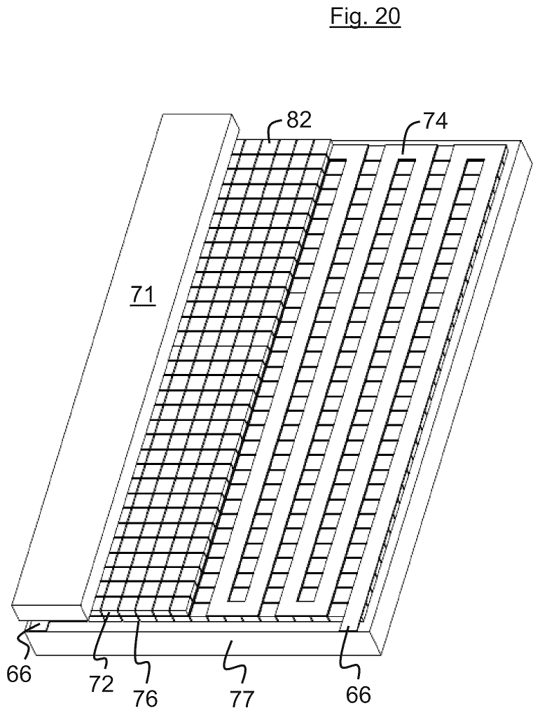

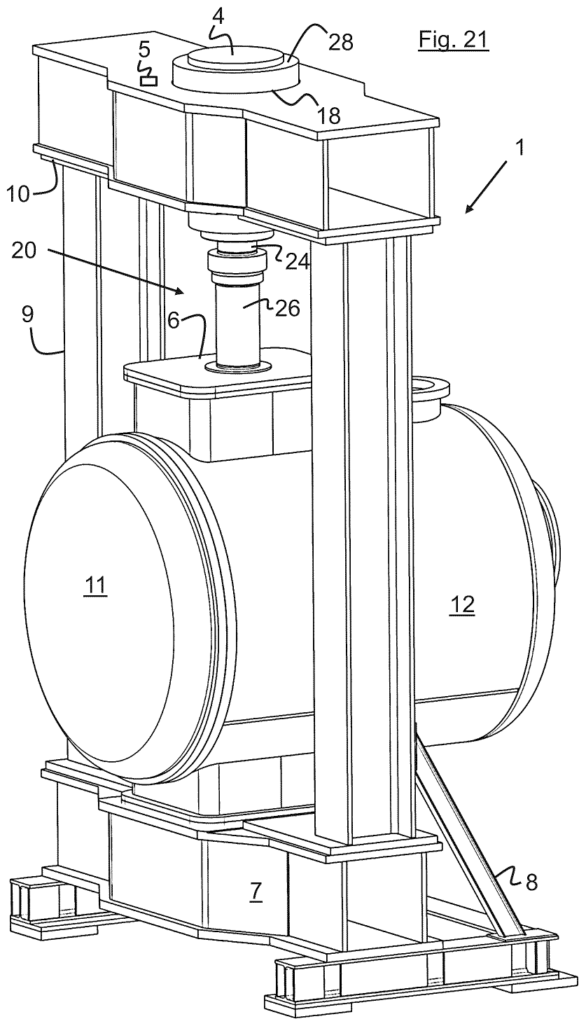

Furthermore, FIG. 1 also shows the possibility of electrically contacting the press plate heating devices 62, 64 by means of contacting devices 100, whereby the course of the current flow runs via the connecting element 112, the feedthrough 114 to the external contact 116. Further details of the contacting devices 100 can be found in FIGS. 17 and 18.

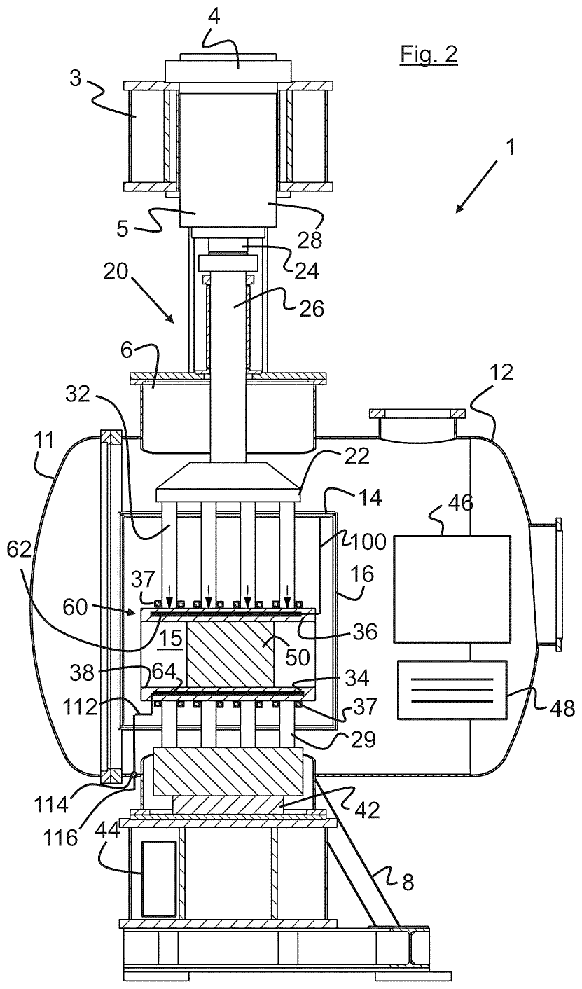

With reference to FIG. 2, the pressing device 20 is shown in an operating position, whereby the press plate 36 is fully positioned against the workpiece 50 and a pressing force is applied to the workpiece 50. The press cylinder 24 or the transfer piece 26 is shown in the disengaged position. In this embodiment, the press plungers 29 and 32 are each equipped with a pressure distribution piece 37, which are arranged at the angle between the press plate 36 and the respective press plunger 32 and assist in transmitting the pressing force even more homogeneously to the press plate 36.

The pressing force applied to the workpiece 50 by the pressing device 20 can be detected by the pressure sensor(s) 42, whereby this is transmitted to the control device 44 as sensor signal 170. Otherwise, the embodiment in FIG. 2 corresponds to that shown and described in FIG. 1. FIG. 2 also shows the electrical contacting of the press plate heating devices 62, 64 by means of electrical contacting devices 100.

FIG. 3 shows a first embodiment of a heating plate 62 for use in a high-temperature joining furnace 1. In the plan view shown, the press plate heating device 62 has a heating element cover layer 72, in which receptacles 68 are provided for fastening means. A connecting projection 66 protrudes laterally on both sides beyond the dimension of the cover layer 72, whereby the connecting projections 66 are associated with the heating element 74.

FIG. 4 shows a cross-section of a press plate heating device 62, whereby the three-layer structure with heating element top layer 72, heating element 74 and heating element bottom layer 76 is recognizable.

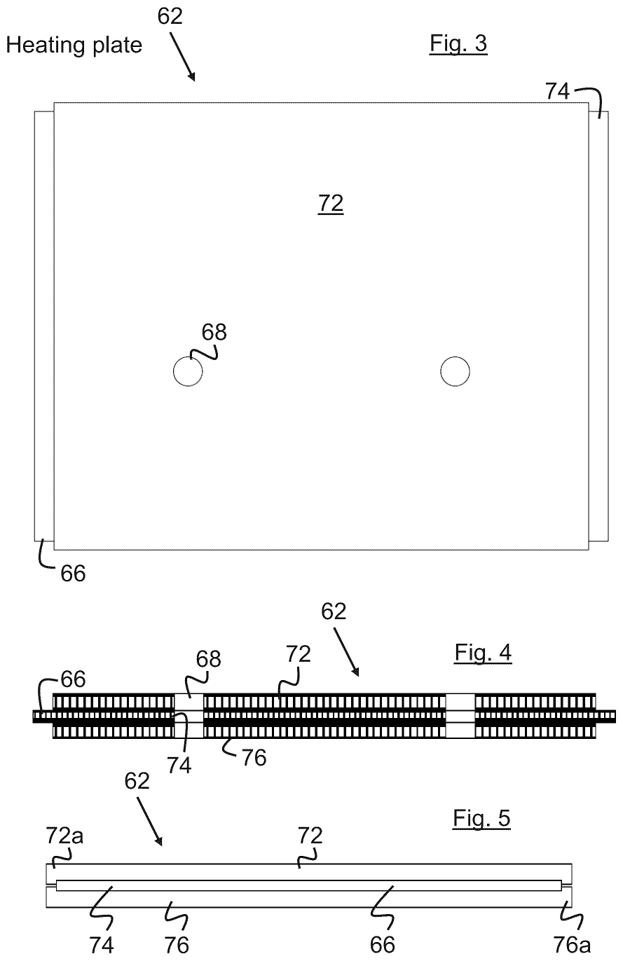

FIG. 5 shows a side view of the press plate heating device 62, whereby the three layers 72, 74, 76 and the connection projection 66 of the heating element 74 are also recognizable. The heating element 74 is laterally enclosed by lateral surrounds 72a, 76a, so that it is surrounded on all sides by the top layer 72 and bottom layer 76, with the exception of the connecting protrusions 66. The connection protrusions 66 serve to introduce the energy required for heating into the heating element 74. For example, an electrical contact can be established by means of the connection protrusions 66.

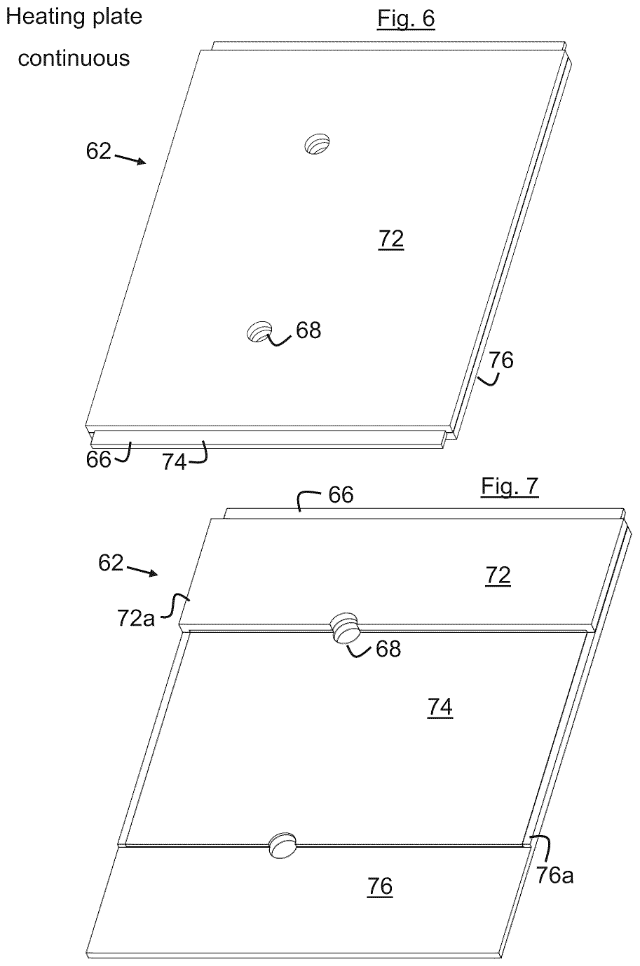

With reference to FIG. 6, a perspective view of a press plate heating device 62 is shown. For example, the heating device 62 shown in FIG. 6 may correspond to the heating device 62 shown in FIGS. 3 to 5. In all figures, the same reference signs stand for the same elements or components. With reference to FIG. 7, the embodiment of FIG. 6 is shown in a stepped section, whereby the three-layer structure comprising top layer 72, heating element 74 and bottom layer 76 is recognizable, as is the enclosure of the heating element 74 by means of the enclosures 72a, 76a.

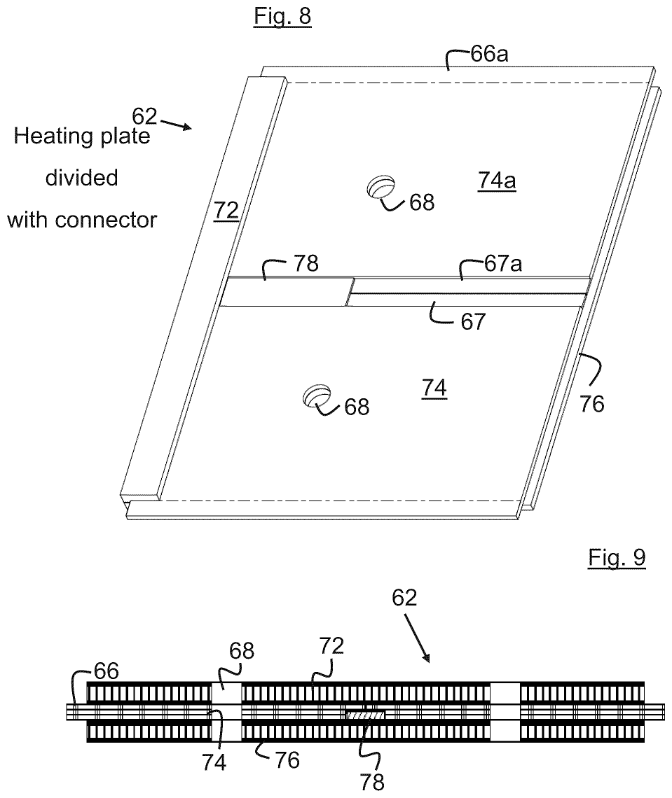

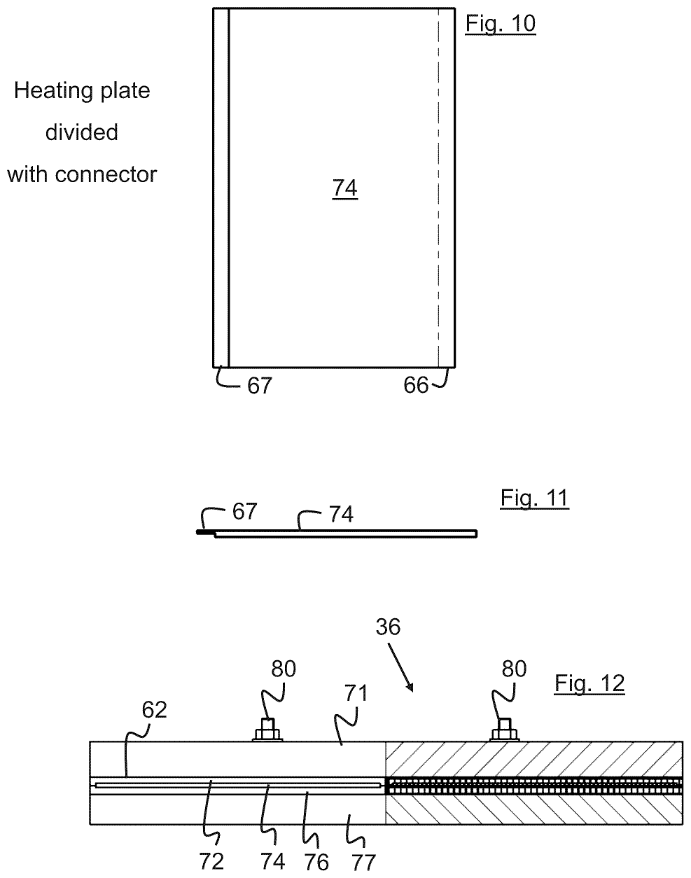

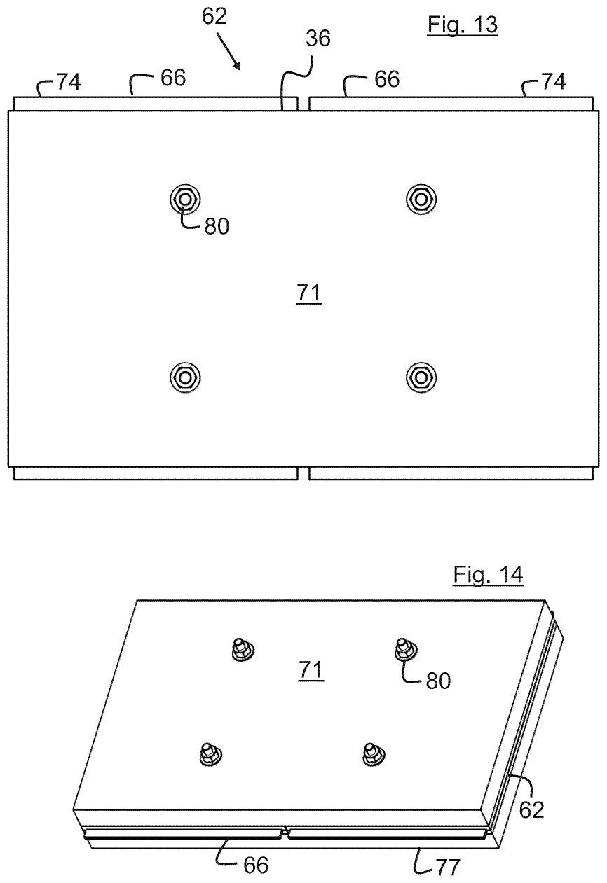

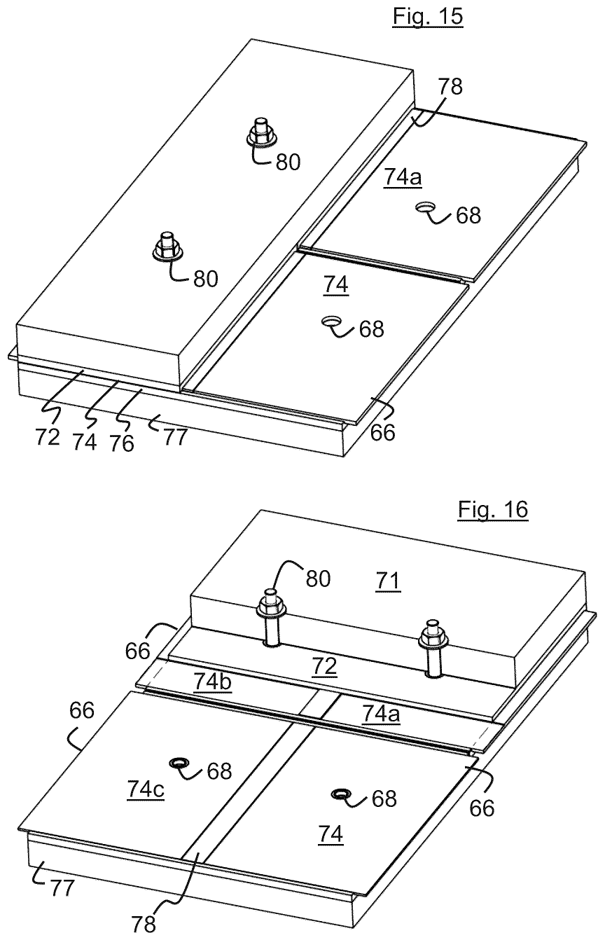

With reference to FIG. 8, a further embodiment of a press plate heating device 62 is shown with a split heating plate 74. In other words, two heating plates 74 are provided, which are jointly surrounded by the top layer 72 and the bottom layer 76. The heating elements 74 are in electrical contact with one another via the contact lips 67 and the connecting piece 78, so that an electrical current flow can be established from a first connection projection 66 via the first heating element 74, the contact lips 67 or the connecting piece 78, the second heating element 74a and the second connection projection 66a. FIG. 9 shows a cross-section of the heating element 62 of FIG. 8, whereby the connecting piece 78 is visible. FIGS. 10 and 11 show a single heating plate 74, for example as part of a split heating plate or heating plane, whereby the connection projection 66 and the contact lip 67 are visible.

The division into several smaller heating plates 74, 74a, 74b, 74c instead of one continuous large heating plate can have several reasons. On the one hand, it was found that a continuous large heating plate 74 is more prone to breakage during operation and can therefore fail earlier than when several smaller heating plates 74, 74a, 74b, 74c are used. Furthermore, any desired materials for manufacturing the press plates 74, 74a, 74b, 74c may not even be manufactured in sizes corresponding to a full size of a current press plate 36 at the time of the preparation of the present application. Finally, it was also established in the context of the present present disclosure that the use of smaller heating plates 74, 74a, 74b, 74c makes it is easier to select for any existing material defects and, moreover, that any existing material defect (crack, flaking, incorrect grain size, pore or cavity, etc.) can be detected in the heating plates 74, 74a, 74b, 74c. Furthermore, any existing material defect (crack, flake, defective grain, pore or cavity, etc.) in the heating plate 74, 74a, 74b, 74c leads less to breakage, since the bending moments (and deflections during operation) that occur are significantly smaller, and thus more material defects can be tolerated, which contributes to an overall reduction in manufacturing costs.

With reference to FIG. 12, a press plate heating device 62 installed in a press plate 36 is shown, wherein the press plate has a press plate element 71 on the press side, a workpiece press plate element 77 and a press plate heating device 62 inserted between these two layers. These layers are connected to each other by means of the fastening means 80, for example screwed together.

With reference to FIG. 13, a top view of a press plate 36 with press plate heating devices 62 is shown. The embodiment of FIG. 13 is shown in perspective in FIG. 14. The press plate heating device 62 is enclosed between the press plate element 71 on the press side and the workpiece press plate element 77 and screwed together with screws 80. With reference to FIG. 15, the embodiment of FIGS. 13 and 14 is shown in a stepped section, revealing the plurality of heating elements 74, 74a, 74b, 74c. The heating elements 74, 74a, 74b, 74c are electrically contacted with each other by means of connecting pieces 78. FIG. 16 shows the same press plate 36 again in a further stepped section, so that the four heating elements 74, 74a, 74b, 74c are revealed. The four heating elements 74 are arranged in a common heating element plane, i.e., next to each other.

Since the heating elements are arranged in the press plate 36, they are typically subjected to movement during operation. Thus, the press plate 36 is placed against the workpiece and, depending on the size of the workpiece etc., the press plate 36 is in a different insertion position during operation. In order to compensate for the different position or movement of the heating elements 74, flexible contacting devices 100 are provided as shown in FIG. 17, which can not only compensate for changes in position, but can also compensate for movements such as impact movements or vibration movements of the press plate or the pressing device 20. For this purpose, the contacting device 100 has a flexible compensation element 104, which dampens and decouples oscillations and vibrations. The contacting device 100 is attached to the heating element 74 with a heating element clamp 102, whereby the connection protrusion 66, 66a is clamped or enclosed. It is also possible to screw it to the connection protrusion 66. The top of the contacting device 100 has a contact element 106, for example to connect a copper strip there for further current conduction. In this embodiment, two contacting devices 100 are connected to a heating element 74 for supplying and-removing current.

FIG. 18 shows the contacting device 100 in a sectional view, the attachment to the connection projection 66 being provided with further details, the stud bolt receptacle 108 and the stud bolt 110 being shown in cross-section. In FIG. 18, a contacting device 100 is connected to two heating elements 74, whereby only one connection side is shown for better graphic visibility. Typically, a second contacting device 100 is used so that a current circuit or current flow can take place through the heating element(s) 74, 74a.

With reference to FIG. 19, a further embodiment of a heating device 62 is shown, wherein the heating element 74 is provided in the form of a ceramic meander. The heating element 74 could, for example, also be designed as a graphite, molybdenum or CFC meander. The ceramic meander 74 is electrically conductive, so that a current flow from the first connection protrusion 66 through the ceramic meander 74 to the second connection protrusion 66a can be realized. The heating device 62 is enclosed in a press plate 36, the press plate having the press plate elements 71, 77. The fastening means 80 are not explicitly shown in this embodiment for reasons of clarity. For example, the plates could be glued together, but typically a screw connection will be desirable due to the high operating temperature.

With reference to FIG. 20, a further embodiment of the press plate heating element 62 is shown, wherein the heating element top layer 72 and the heating element bottom layer 76 are designed as tiles. The heating element 74 is accordingly embedded in the tiles 72, 76, 82. Accordingly, any unevenness or joints are evened out and are therefore less visible as a restriction in the workpiece 50.

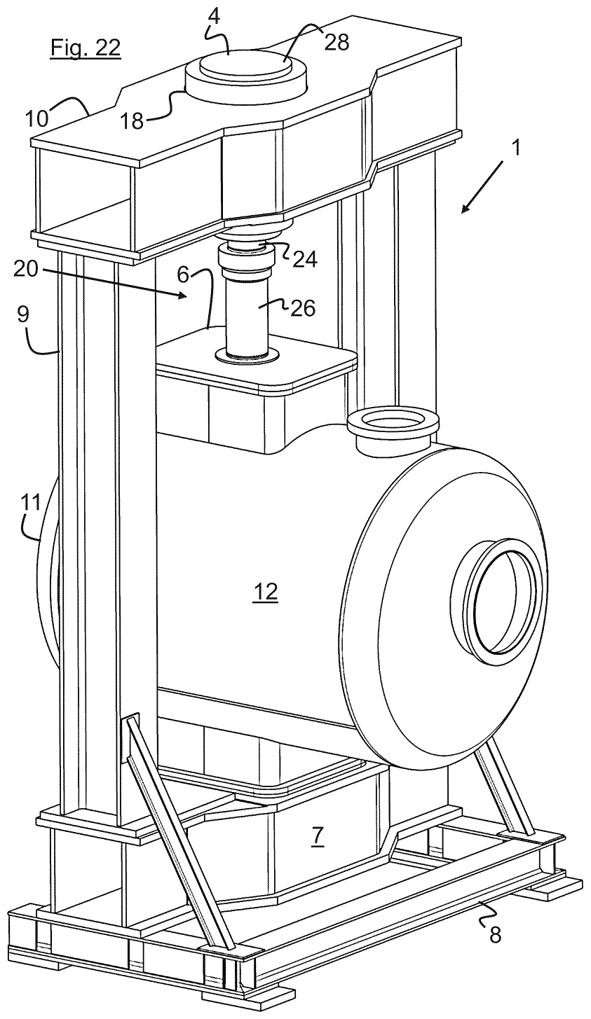

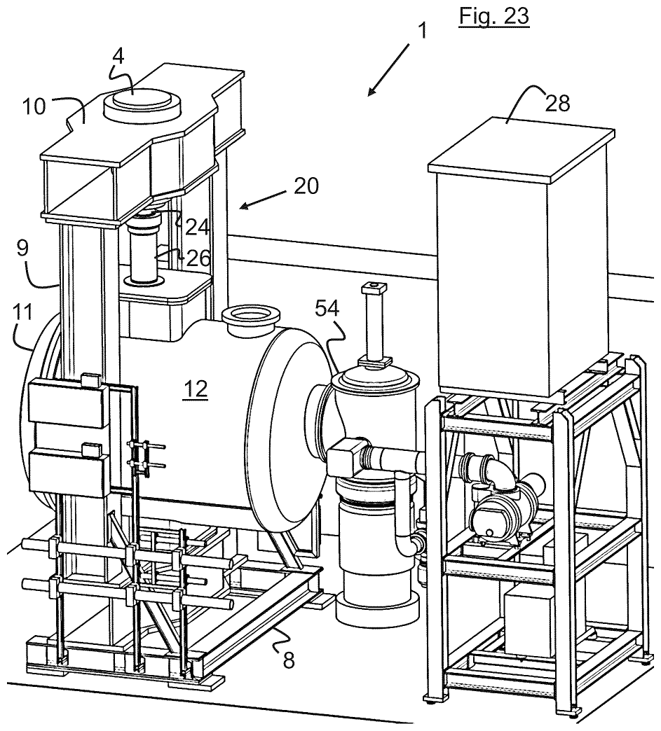

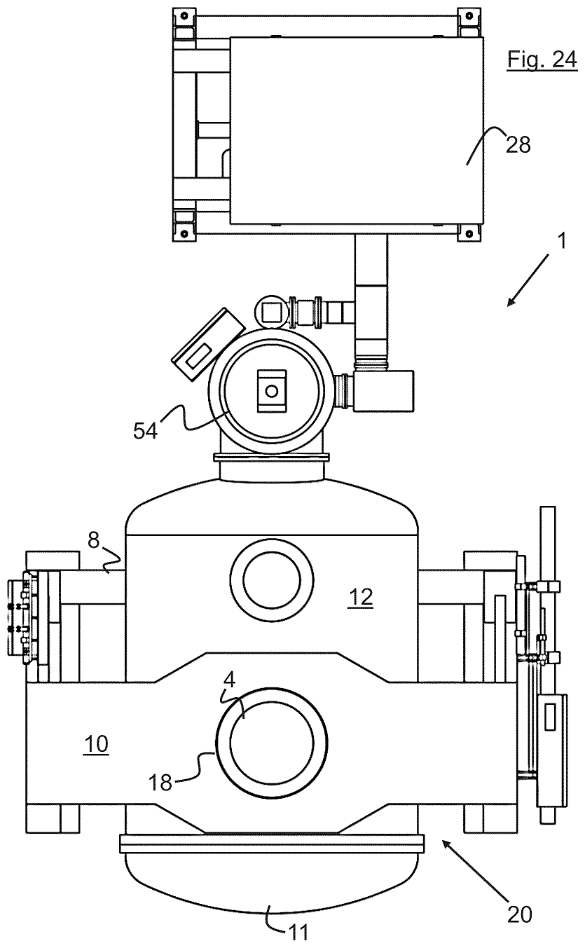

With reference to FIGS. 21 and 22, a high-temperature joining furnace 1 is shown, whereby an outer frame 7, 9, 10 is included to support the pressing device 20. The pressing cylinder 24 is supported by the supporting frame element 10, so that the pressing force can be transferred from the pressing device 20 to the workpiece 50 (see e.g. FIGS. 1, 2) arranged inside the high-temperature joining furnace 1. When the pressing force is applied, the total force is absorbed by the outer frame 7, 9, 10, which can bend up in one direction away from the joining furnace 1 during operation. The bending up of the outer frame 7, 9, 10 provides a dynamic bearing for the pressing device 20, so that a press abutment 18 is formed by the outer frame 7, 9, 10. In FIG. 23, a position sensor 5 is provided with which the positional displacement of the press abutment 18 can be detected. The positional displacement can also be used to draw conclusions about the pressing force applied by the pressing device 20 and the information can be provided as a sensor signal.

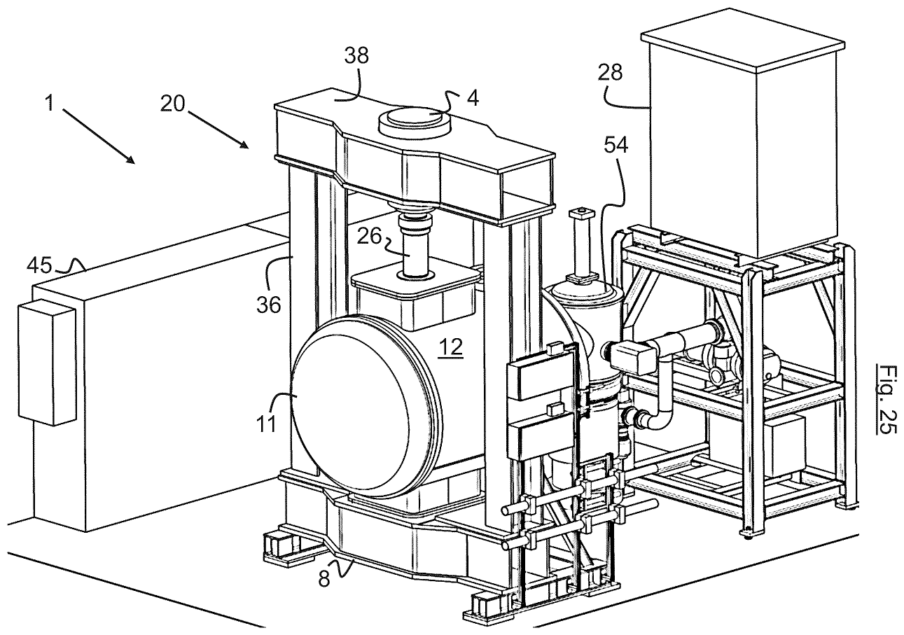

FIGS. 23 to 25 show a further embodiment of a high-temperature joining furnace 1, which is now shown completed with further attachments. A vacuum generator 54, for example a turbomolecular pump, provides a vacuum extraction system so that the joining process in the high-temperature joining furnace 1 can be carried out in a vacuum, for example a high vacuum or an ultra-high vacuum. The pressing force generator 28 is located in a separate housing, so that a larger unit can be accommodated there if necessary. An input and/or output device 48, 46 is outsourced to a user terminal 45, which comprises the PLC 44 and input/output 48, 46.

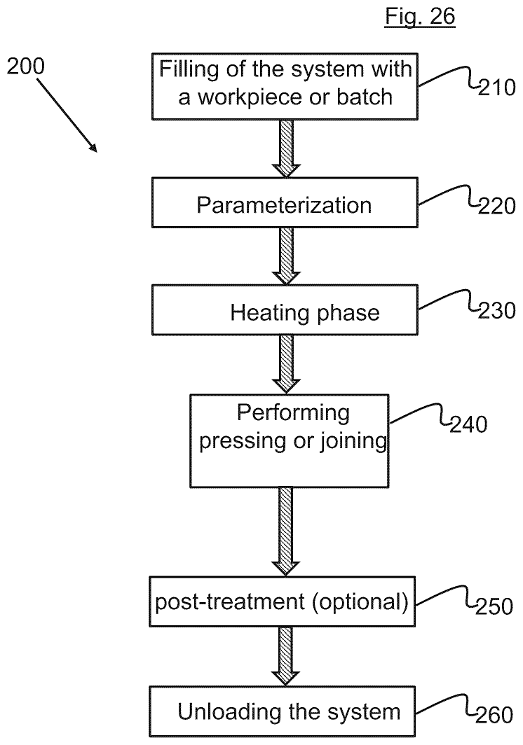

With reference to FIG. 26, a flow diagram of a joining process 200 is shown. In a first step 210, the system is filled with a workpiece 50 or a batch of one or more workpieces. This is typically carried out by a user, but can also be automated. In a step 220, the system 1 is parameterized, whereby various specifications, such as for example the materials and joining surfaces of the workpiece or the batch 50, can be stored in the control device 44 using an input device 48. For example, the intended compression of the workpiece 50 or the batch can also be entered as a percentage or distance, e.g. in millimeters. Temperature specifications can also be stored, for example. The parameters entered for step 220 can be transmitted to a control device 44. The control device 44 can then generate a set of control parameters. After closing the filling opening 11, the joining furnace 1 is now ready for operation. The process phase 230 begins, e.g., with temperature parameters provided by the control device 44. The press 20 is then prepared. This may involve applying a pre-pressure to the pressing device 20 so that the abutment 18 is displaced or deformed or preloaded and the pressing device 20 can thus assume an initial position. During this process, or even before or after it, the workpiece 50 is heated in the heating phase 230, during which the press plate heating device 62, 64 is heated and the heat is transferred evenly to the workpiece 50 by conduction.

The pressing process or the joining process is then carried out in step 240; if necessary, this can be monitored and adjusted by the automatic process control 44. Sensors 4, 5, 42 may provide sensor signals which are processed by the process control 44. The prepared control parameters may be checked or adjusted in response to the sensor signals provided by the sensors 4, 5, 42. If the control parameters are adjusted, the joining process 240 is continued in a modified form using the adjusted control parameters. This can be implemented as a control loop and can be carried out iteratively, for example, so that an improved parameter configuration can be set in the course of the joining process and an improved joining result can be achieved. In other words, in one example, a compression of the workpiece 50 by X% is specified. This takes place within a certain time, which can be calculated by the control system. An initial pressing force is applied and the actual pressing process begins in step 240. During the execution of the pressing process 240, it is possible to check whether the corresponding distance per unit of time has been reached and change the pressing force if necessary.

Here, for example, an increasing pressing pressure can be stored, which can be adaptively adjusted during the joining process 240. A maximum or desired deflection of the press cylinder 24 to a desired end value can also already be stored in the set of original control parameters. During the checking or adjustment of control parameters, it can also be determined whether the desired final value for the deflection of the press cylinder 24 and/or the deformation of the workpiece can be achieved without possibly exceeding a press pressure with which the workpiece or the batch 50 could possibly suffer damage or excessive deformation.

In a step 250, the workpiece or the batch 50 may undergo further treatment. This can be further tempering, further heating or cooling with a defined temperature constant. Following the post-treatment 250, the workpiece or the batch 50 is sufficiently cooled and can be removed from the system 1 in step 260.

In the present description, it has thus been possible to set out a functional solution in a large number of examples, which also contain features that can be individually combined with one another, as to how the homogeneity of the heat distribution in the workpiece 50 can be improved and/or the time required to heat the workpiece 50 can be reduced by integrating a heating device 62, 64 directly into the press plate 36, 38, for example by means of conductive heat transfer. In addition, materials can now be processed by means of diffusion bonding which were previously not open to this process due to the low temperature ranges required.

Conductive heating of the press plates 36, 38 by one or more heating elements 74, 74a, 74b, 74c, which may be made of ceramic or another heating material, has proven to be helpful for this purpose. The heater 62 is preferably an electrical resistance heater that is integrated in an electrically insulated manner. A circumferential heater 14 can be provided for support in order to equalize the temperature at the edge and in the corners of the component 50. The support or circumferential heating can be moved vertically. The support heater can be divided into different temperature zones if necessary. Water-cooled pressure distribution plates 36, 38 can be used if necessary. A flexible heater connection 100 can be realized, for example, via copper strips 112.

One objective is to make the diffusion bonding of large-format components (possibly larger than DIN A3 format) more efficient. Efficiency refers to the energy consumption per welding cycle as well as the duration of a joining cycle. This can be achieved by heating the components to be joined via conduction—i.e., contact heating.

With the increasing degrees of freedom in terms of design due to additive construction methods, there is also a desire to scale up the previous sizes of component volumes. Although the build volumes of powder bed systems have also grown in recent years, with systems measuring 500×280×850 mm³ currently commercially available, build rates are still low, especially when it comes to massive components such as molds. An alternative additive build-up process is material deposition with directed energy deposition (DED) using an electric arc and wire as a filler material. High build-up rates in the range of several kilograms per hour are possible. However, the disadvantage here is the inadequate possibility of producing internal channels. In principle, these are feasible, although the dimensional accuracy and dimensional stability have so far only been sufficient for cooling channels at most. Functions such as the distribution of plastic mass or heat exchanger structures are currently not feasible. Diffusion bonding is therefore already being used today for such components. The size scaling of diffusion bonding systems with regard to the press plates currently available on the market is in the range of over one meter.

One aim of the present description was the development and elaboration of design boundary conditions for a heating concept for diffusion bonding, which homogenizes the heat input into the component and, if possible, realizes it through contact heating, i.e., heat conduction. The aim is to achieve process temperatures of up to 900° C., for example, and the possibility of dynamic force application. Furthermore, the system is to be designed for use in high-vacuum furnaces. Conductive heating avoids the lossy and emission-dependent heat transfer by radiation that occurs in a vacuum, whereby the energy input into the mostly plate-shaped joining parts is considerably more efficient, homogeneous and faster. The result is a heating system that enables a significant increase in energy efficiency during diffusion bonding and significantly shorter cycle times. This significantly reduces the costs of the diffusion bonding joining process, improves component quality and increases the competitiveness of the process.

Of particular interest is the heat conduction or heating of the components to be joined 50. Especially for non-ferrous metals, whose joining temperatures are below 1,000 C, the previously established heating by thermal radiation in a vacuum is an inefficient process. Due to the low emissivity, only very low heating speeds were possible, which has a negative effect on the cycle time and therefore the costs of the process. Direct (conductive) component heating by heat conduction via the press plate 36, 38 accelerates the energy input into the component 50 and at the same time enables a more homogeneous temperature distribution, as the heat is introduced evenly over the largest surfaces of a plate-shaped component, while conventional heating is carried out via the outer edges, resulting in a gradient between the outside and the center of the component due to the path length, which leads to differences in the quality of the composite formation if not equalized by waiting (extending the cycle time). The size of the press plate surface can be at least 300×500 mm or larger. The cyclic load capacity of the system 1 is preferably 0.1 Hz or more, or even 0.5 Hz or more, or even 1 Hz or more. Operation in a fine or high vacuum of at least 10-5 mbar is helpful. A transmittable surface pressure ≥7 N/mm² can be achieved on the system side. For example, a surface pressure of at least 0.1 MPa can be achieved on the component 50 using the press plates 36, 38, preferably at least 0.5 MPa. For example, the surface pressure can be achieved up to a maximum of 50 MPa, possibly a maximum of 40 MPa. Alternatively or cumulatively, a force of 1 ton or more can be exerted on the component 50 by means of the press plates 36, 38, in which case the system can even be used for power-assisted brazing (PAB). Preferably, a force of 5 tons or more can be exerted on the component 50 by means of the press plates 36, 38. If necessary, the force exerted on the component 50 by means of the press plates 36, 38 can be up to 5,000 tons, for example also up to 4,000 tons. Lower surface pressures of less than 0.1 MPa or application of forces of less than 1 ton are not understood as a pressing force or application of a pressing force for the purposes of this application. For example, processes for wafer bonding, i.e., the joining of semiconductor boards, are not pressing processes within the meaning of this application. Rather, the field of diffusion bonding or force-applied soldering within the meaning of the present application is subject to the aforementioned comparatively high-pressure regime.

Three main factors are useful for the diffusion bonding process on the system side: the atmosphere in which the joining takes place, the way in which the force is applied and the heating concept. If, in addition to the process, the component geometry is also taken into account, the system concept, i.e., the design of the welding system, should also be considered. In principle, the components to be joined in a vacuum can be heated in a variety of ways, by means of heat radiation, laser or electron beam, convection, direct resistance heating, induction, heat conduction (conduction) or a combination of individual variants. The beam-based processes (laser or electron beam) are particularly suitable for rotationally symmetrical small parts, but have the disadvantage that an additional axis must be provided in the system (rotation axis for turning the workpiece). Direct current application to the components to be joined leads to direct resistance heating, but the component size is also limited here due to the electrical variables. If the direct current is replaced by a pulsed current flow, larger currents can be converted. In this case, sparkovers also occur, comparable to plasma spark sintering. Due to the direct current flow through the components, only electrically conductive materials can be joined, whereby a homogeneous distribution of the electric field must be ensured, especially for large components. Induction heating is used much more frequently, especially historically. Here, the heat is generated directly in the area of the component surface, which heats the component quickly. Diffusion bonding systems for mass production, e.g., for valve disk sealing rings with production figures of 3.1 million units per year, were already equipped with induction heating in the 1970s. The penetration depth can be adjusted via setting parameters such as frequency or current.

However, the component-inductor distance or the shape of the inductor also influence the heat input and thus the temperature distribution in the component. A disadvantage is that the inductor must be adapted to the component geometry for optimum heating and not all materials can be heated inductively. Induction heating is nevertheless suitable for slim component geometries, for example.

However, the current trend in terms of component dimensions is towards solid, flat components with large dimensions in at least two spatial directions, e.g., plate heat exchangers or injection molds. For this reason, the diffusion bonding systems of the latest generations are typically designed according to the “furnace principle”. This means that a vacuum furnace system forms the basis for the welding system, into which a “press system”20 is integrated. Heating takes place via heat radiation, most frequently via resistance-heated elements. Infrared radiators can also be used for small parts. As there is no convection in a vacuum, the heat transfer is limited to radiant heating between the heating element and the component. The main influencing factor in radiant heating is the degree of absorption of thermal radiation depending on the condition of the component surface. According to Kirchhoff's radiation law, which states that radiation absorption and emission correspond to each other at a given wavelength, only the emissivity is often specified.

Molybdenum can be considered as a heating element material in air and in a vacuum. The oxide layer on the molybdenum is dissolved in a vacuum and thus a high degree of emissivity is achieved in a vacuum, which is why the material is used for heaters. Furthermore, two typical material groups of the components to be joined are included, aluminum and steel. Purified steel has a comparatively high emissivity. This is temperature-dependent and increases with temperature. In comparison, the value for aluminum is significantly lower. Cleaned aluminum has very low values, whereas oxidized aluminum surfaces have a value that is only 2 to 3 times lower than that of steel. From the point of view of radiation technology, oxidized surfaces are optimal with regard to the absorption of heat radiation, but not from the point of view of diffusion bonding, as oxide layers represent a diffusion barrier. Copper materials behave similarly to aluminum. This means that heating highly thermally conductive materials by radiation alone may not be sufficient for the welding process. For materials with a low tendency to react with the environment, heat transfer by means of partial pressure in the working chamber can be increased in addition to pure radiant heating (additional convection component). In the case of aluminum and titanium alloys, impurities contained in the gas (e.g. oxygen / nitrogen) lead to a reaction with the surface and the formation of layers, which in turn have a diffusion-inhibiting effect and can negatively influence the mechanical-technological properties.

Another disadvantageous aspect of the heating concepts described above is the temperature homogeneity in the component. In principle, heat is always transferred via the component surface and is conducted from there into the interior of the component by heat conduction. Accordingly, a temperature gradient forms in the component 50 during heating, which leads to uneven expansion and internal stresses. Depending on the thermal conductivity of the material to be joined, this circumstance should be countered by correspondingly slow heating rates, also in order to avoid heat build-up and overheating of the component surface. In addition to the material, the aspect ratio of the component is helpful. The concepts described above realize the heat input mainly via the side surfaces of the component. This means a maximum heat conduction path for plate-shaped components. However, such component geometries with a low aspect ratio are currently increasingly in demand (plate heat exchangers, mold inserts, etc.). The heat input via the base and top surface therefore shortens the conduction path and thus allows higher heating speeds.

Press plates for diffusion bonding systems fulfill the task of introducing the pressing force into the component and distributing this force as homogeneously as possible over the component or the joining surface. This initially results in a basic requirement for the mechanical properties of the plate 36, 38, such as a low modulus of elasticity and sufficient compressive and flexural strength. Due to the use in a high-vacuum furnace system, these properties should be guaranteed over the entire range of application temperatures. Furthermore, the press plate material should be suitable for use in a vacuum (high vapor pressure). In addition, the ideal press plate material should have a low specific heat capacity, as the press plates represent dead mass from an energy point of view, which should be heated up and cooled down again during the process. Another requirement is fatigue strength under dynamic load in the pressure threshold range.

In the field of metallic materials, titanium-zirconium-reinforced molybdenum (TZM) is a good starting point and is used in many areas as a load-bearing element in the heating area of vacuum furnace systems. In addition to its thermal and mechanical properties, its behavior during machining is comparable to that of CrNi steels. Accordingly, TZM is also of interest for the present description. The disadvantages of TZM are its comparatively high density of 10.2 g/cm³, the high thermal conductivity characteristic of metals and the high production-related costs.

All-ceramic press plates are the ideal press plate material from a mechanical point of view. Silicon carbide ceramics, for example, have a high modulus of elasticity of 350-450 GPa but also a compressive strength of over 2500 MPa, resulting in a very dimensionally stable material. The main disadvantage of ceramics is the high cost of processing in the sintered state.

Steel materials such as the heat-resistant steel 1.4828 are conceivable as a press plate material. However, the low creep rupture strength of less than 5 N/mm² at the desired application temperature of 900° C. is a criterion for exclusion.

An alternative to the aforementioned are ceramic-based fiber composites (CMC). Similar to carbon fiber-reinforced plastics, carbon fibers or ceramic fibers are embedded in a ceramic matrix. This retains the outstanding properties of ceramics, such as temperature resistance and compressive strength, but the fiber reinforcement increases the fracture toughness required for dynamic use.

Carbon fiber reinforced graphite (CFC) can be used in diffusion bonding systems with static force application. Due to the high thermal conductivity compared to the other fiber composites considered here, more energy is extracted from the heating zone.

Carbon fiber-reinforced silicon carbide is a composite material. This material has not yet been used in diffusion bonding systems.

Aluminum oxide fiber-reinforced oxide ceramics have a very low thermal conductivity of 0.4-2.7 W/mK and a relatively low modulus of elasticity (40 GPa), which would lead to excellent insulation and very good pressure distribution. However, the low compressive strength of approx. 25 N/mm² may be desirable for this material.

The general requirements of heater materials for the heating device 62, 64 may be a high electrical resistance, a high melting temperature, which should significantly exceed the application temperature, and a low vapor pressure in order to minimize heater wear in vacuum operation. From a design point of view, a low coefficient of thermal expansion is also desirable. In the field of metallic materials, molybdenum stands out as a heater material alongside tungsten. With a melting temperature of 2623° C., a specific electrical resistance in the range of 0.056·10−6-0.452·10−6 Ωm (20-1500° C.) and a coefficient of expansion of 5.8·10−6 K-1, it is possible to achieve temperatures of up to 1600° C. with very high vacuum quality.

An alternative to this are nickel-based alloys, which have a higher mechanical strength and toughness with comparable electrical resistance (e. g: Nicrofer® 0.103·10−6-0.114·10−6 Ωm (20-1000° C.). However, the range of applications is limited due to the lower melting temperature (1370-1425° C.) and the comparatively high expansion coefficient of 16.9·10−6 K-1 (1000° C.).

In addition to metallic materials, it is also possible to realize resistance heating with non-oxide ceramics such as SiC. These are now also commercially available as heating plates for temperatures up to 1100° C., allowing a homogeneous temperature distribution to be achieved. However, the high brittleness and sensitivity to bending stress may be desirable with regard to the planned application.

Graphite is another alternative for heating furnace systems; wherein graphite has comparatively low material price and high electrical resistance. However, graphite is only suitable for use in a high vacuum to a limited extent, as evaporating carbon can contaminate the parts to be joined and cause material changes.

It is apparent to the skilled person that the embodiments described above are to be understood as illustrative and that the invention is not limited to these, but can be varied in many ways without leaving the scope of protection of the claims. Furthermore, it is apparent that the features, irrespective of whether they are disclosed in the description, the claims, the figures or otherwise, also individually define portions of the present disclosure, even if they are described together with other features. In all figures, the same reference signs represent the same objects, so that descriptions of objects which may only be mentioned in one or at least not with respect to all figures can also be transferred to these figures, with respect to which the object is not explicitly described in the description.

1. A high-temperature joining furnace, for diffusion bonding of joining workpieces, comprising:
a heating chamber,
a workpiece holder arranged in the heating chamber for holding a workpiece to be processed in the joining furnace,
a pressing device arranged and prepared to apply a pressing force to the workpiece, the pressing device comprising a press plate for uniformly applying the pressing force to the workpiece,
wherein the press plate is equipped with a press plate heating device for heating the press plate and/or the workpiece.

2. The high-temperature joining furnace of claim 1,
wherein the press plate heating device is integrated into the press plate, and/or
wherein the press plate is a multi-part press plate, wherein the press plate comprises a workpiece-side element and a press-side element, and/or
wherein the press plate heating device is arranged between a workpiece-side layer and a press-side layer.

3. The high-temperature joining furnace of claim 1, further comprising flexible connection connectors for connecting the press plate heating device to an energy source.

4. The high-temperature joining forma of claim 3,
wherein the press plate heating device provides a conductive heat output, i.e. is a conductive press plate heating device, and/or
wherein the press plate heating device is arranged to be electrically operable, so that it emits heat when it is supplied with electrical power from the energy source, and/or
wherein the press plate heating device is arranged to allow fluid to flow through it, so that the pressing device emits heat when the press plate heating device is supplied with a hot fluid from the energy source.

5. The high-temperature joining furnace of claim 1,
wherein the pressing device comprises a hydraulic device as pressing force generator and builds up the pressing force by building up a hydraulic pressure, and/or
wherein the pressing device comprises an electrospindle, and/or
wherein the pressing device comprises a pressing cylinder, and/or
wherein the pressing device comprises a plurality of pressing punches, in particular two, three, four or more pressing punches.

6. The high-temperature joining furnace of claim 1,
wherein the high-temperature joining furnace comprises an outer frame, and
wherein the pressing device is arranged on the outer frame and/or is supported on the outer frame, and/or
wherein the outer frame is designed to be movable and/or deformable.

7. The high-temperature joining furnace of claim 1,
furthermore having a press abutment which is prepared in such a way that a lateral displacement and/or deformation of the press abutment takes place by application of is compressive force by the pressing device to the workpiece and/or
wherein the pressing device is set up in such a way that a prestressing force can be built up to a supporting frame element during a pressing operation, and/or
wherein the workpiece holder serves as a counter-pressing element, and/or
wherein the pressing device presses the workpiece against the workpiece holder

8. The high-temperature joining furnace of claim 1,
for carrying out joining processes, of metal or metal workpieces, at temperatures of 1200° C. or lower, and/or at temperatures of 450° or higher, and/or
for carrying out joining processes, of non-metals workpieces, at temperatures of 350° or lower, and/or at temperatures of 80° or higher,

9. The high-temperature joining furnace of claim 1, further comprising a furnace heating device for emitting radiant heat into the heating chamber.

10. A method for diffusion bonding in a high-temperature joining furnace comprising the following steps:
loading a joining furnace with a workpiece,
applying at least one press plate of a pressing device to the workpiece,
heating the workpiece by a press plate heating device to a joining temperature,
pressing the workpiece with the pressing device to carry out a diffusion bonding process.

11. The method according to claim 10, further comprising the step of
during pressing, tempering or heating the press plate using the press plate heating device for homogenizing temperature distribution in the workpiece.

12. A heatable press plate for a high-temperature joining furnace, comprising:
the heatable press-plate being prepared for uniform application of a pressing force to a workpiece placed in the high-temperature joining furnace,
wherein the plate is equipped with an integrated press plate heating device for heating the press plate and/or the workpiece.

13. The heatable press plate of claim 12,
wherein the press plate heating device is integrated into the press plate, for -and/or
wherein the press plate is a multi-part press plate, the ding a workpiece-side element and a press-side element, and/or
wherein the press plate heating device is arranged between a workpiece-side layer and a press-side layer.

14. The heatable press plate according to claim 13,
wherein each part of the press plate is composed of an identical base material and has different dopings from one another.

15. The heatable press plate according to claim 14,
wherein the press plate comprises ceramic material, and/or
wherein the workpiece-side layer and/or the press-side layer comprises ceramic material or consists of ceramic material, and/or
wherein the press plate heating device comprises ceramic material or metal material or consists of ceramic material or metal material.

16. The heatable press plate of claim 15,
wherein the ceramic material comprises at least one of carbon fiber reinforced graphite, carbon fiber reinforced silicon carbide, titanium zirconium reinforced molybdenum, silicon carbide or alumina fiber reinforced oxide ceramic, or the workpiece side layer and/or the press side layer is made of one of the aforementioned materials, and/or
wherein the press plate heating device comprises or consists of at least one of tungsten, molybdenum, a nickel-based alloy such as Nicrofer®, a non-oxide ceramic such as silicon carbide or graphite, or a carbon fiber-reinforced carbon.

17. The heatable press plate of claim 12,
wherein the press plate heating device is of plate-shaped design, and/or
wherein the press plate heating device is of meander-shaped design, and/or
wherein the press plate heating device has channels or tracks and the channels or tracks pass through the press plate so uniformly that material of the press plate is at most at a distance from one of the channels or tracks which corresponds to twice a width of the channels or tracks or less.

18. The heatable press plate of claim 12,
wherein the press plate heating device is arranged to be electrically operable so that it emits heat when current is applied to it, and/or
wherein the press plate heating device is arranged so that fluid can flow through it so that it emits heat when a hot fluid is applied to it.

19. The heatable press plate of claim 12,
wherein the press plate heating device comprises at least two heating plates, and/or
wherein the press plate heating device comprises a connecting piece for connecting two or more partial regions such as heating plates wherein the connecting piece comprises or consists of graphite.

20. The heatable press plate of claim 19,
wherein the connecting piece is designed to be reversibly deformable, so that it deforms when a compressive force is applied, come wider, and improves or establishes electrical contact between the heating plates of the press plates heating device.

21. The heatable press plate of claim 12,
further comprising a pressure equalization layer, wherein the pressure equalization layer is designed to be full-surface and is arranged to be flexible or compressible, and/or
wherein the pressure equalization layer is arranged adjacent to the press plate heating device, and/or
wherein the pressure equalization layer is a graphite foil.

22. The heatable press plate of claim 13,
wherein the press-side layer is formed as a tile carpet, and/or
wherein the press plate heating device is arranged in a heating plane, and/or
wherein ceramic tiles are arranged between components of the press plate heating device.
